(19) United States
(12) Patent Application Publication
(10) Pub. No.: US 2026/0237586 A1
(43) Pub. Date: Aug. 13, 2026

(54) DISCONNECT SWITCH

(71) Applicant: Eaton Intelligent Power Limited, Dublin (IE)

(72) Inventors: Himaprava Panda, Puri (IN); Travis Spoone, Greenwood, SC (US); Ajinkya Abdar, Pune (IN); Michael Davis Pearce, Plum Branch, SC (US); Bhushan Kadu, Pune (IN); Prashant Zatale, Pune (IN)

(21) Appl. No.: 19/466,939

(22) Filed: Feb. 2, 2026

(30) Foreign Application Priority Data
Feb. 10, 2025 (IN) 202511010880

(51) Int. Cl. H01H 85/055; H01H 85/143; H01H 85/165

(52) U.S. Cl. CPC H01H 85/055; H01H 85/143; H01H 85/165

(57) ABSTRACT

A disconnect switch includes: a housing; a first stationary contact in an interior of the housing; a second stationary contact in the interior of the housing; and a disconnection assembly that includes: a movable electrical contact; and an operating interface accessible from an exterior of the housing and coupled to the movable electrical contact, the operating interface configured to move the movable electrical contact into and out of electrical connection with the first and second stationary contacts. The disconnect switch also includes a blocking assembly configured to prevent the movable electrical contact from being removed from the interior of the housing.

### CROSS-REFERENCE TO RELATED APPLICATION

This application claims priority to Indian Patent Application No. 202511010880, filed Feb. 10, 2025 and titled DISCONNECT SWITCH, which is incorporated herein by reference in its entirety.

### TECHNICAL FIELD

This disclosure relates to a disconnect switch.

### BACKGROUND

A disconnect switch includes stationary electrical contacts and a movable electrical contact. The state of the disconnect switch is changed from ON to OFF and OFF to ON by moving the movable electrical contact relative to the stationary electrical contacts.

### SUMMARY

In one aspect, a disconnect switch includes: a housing; a first stationary contact in an interior of the housing; a second stationary contact in the interior of the housing; and a disconnection assembly that includes: a movable electrical contact; and an operating interface accessible from an exterior of the housing and coupled to the movable electrical contact, the operating interface configured to move the movable electrical contact into and out of electrical connection with the first and second stationary contacts. The disconnect switch also includes a blocking assembly configured to prevent the movable electrical contact from being removed from the interior of the housing.

Implementations may include one or more of the following features.

The first stationary contact and the second stationary contact may be separated by a gap; and, when the movable electrical contact is in electrical connection with the first and second stationary contacts, the movable contact may touch the first and second stationary contacts.

The disconnect switch also may include a fuse in the interior of the housing, the fuse electrically connected to the second stationary contact.

The movable electrical contact may be mounted on a rod that extends along an axis, the movable electrical contact extends in a plane perpendicular to the axis. The movable electrical contact may be shaped to restrict rotation in the plane. The movable electrical contact may have a non-circular shape in the plane. The operating interface may be configured to move the movable electrical contact along the axis. The operating interface may be a handle configured to be pulled away from the housing to move the movable electrical contact out of electrical connection with the first and second stationary electrical contacts and to be pushed toward the housing to move the movable electrical contact into electrical connection with the first and second stationary electrical contacts.

In some implementations, the disconnect switch also includes a visible break system that provides a perceivable indication of whether or not the movable electrical contact is electrically connected to the first and second stationary electrical contacts. The visible break system may include at least one window aligned with a region between the first stationary contact and the second stationary contact.

The operating interface may be configured for manual manipulation, and the operating interface may move the movable contact in response to manual manipulation.

The operating interface may be driven by a mechanized element. The mechanized element may be a motor.

In another aspect, a fused disconnection system includes: a first stationary contact; a second stationary contact separated from the first stationary contact; a fuse; and a movable electrical contact configured to move between a first position and a second position. When the movable electrical contact is in the first position, the first stationary contact, the second stationary contact, and the fuse are electrically connected; and, when the movable electrical contact is in the second position, the first stationary contact and the second stationary contact are not electrically connected.

Implementations may include one or more of the following features.

The fuse may move with the movable electrical contact.

The fused disconnection system also may include a housing, and the movable electrical contact may move relative to the housing, and the fuse may be in the housing. The housing also may include a view window aligned with the first and second stationary contacts.

The fused disconnection system also may include: a first electrical terminal electrically connected to the first stationary contact; and a second electrical terminal electrically connected to the second stationary contact. The second electrical terminal may be electrically connected to the second stationary contact through the fuse.

The first stationary contact may be accessible from an exterior of the housing; the second stationary contact may be accessible from an exterior of the housing; and each of the first and second stationary contacts may be configured to electrically connect to an external device.

Implementations of any of the techniques described herein may include an apparatus, a disconnect switch, a method, or a system. The details of one or more implementations are set forth in the accompanying drawings and the description below. Other features will be apparent from the description and drawings, and from the claims.

### DRAWING DESCRIPTION

FIG. 1A is a block diagram of an example of a system.

FIG. 1B is a block diagram of another example of a system.

FIGS. 2A and 2B are cross-sectional views of an example of a disconnect switch.

FIGS. 3A and 3B are cross-sectional views of another example of a disconnect switch.

FIG. 4A is an exterior front view of another example of a disconnect switch.

FIG. 4B is an exterior side view of the disconnect switch of FIG. 4A.

FIG. 4C is a side cross-sectional view of the disconnect switch of FIG. 4A in a closed state.

FIG. 4D is a side cross-sectional view of the disconnect switch of FIG. 4A in a opened state.

FIG. 4E is a perspective view of an example of a blocking assembly that may be used in the disconnect switch of FIG. 4A.

FIG. 5 is a perspective view of an example of a movable contact.

FIG. 6A is an exterior perspective view of another example of a disconnect switch.

FIG. 6B is a perspective cross-sectional view of the disconnect switch of FIG. 6A.

FIG. 6C is a partial cross-sectional side view of the disconnect switch of FIG. 6A in a closed state.

FIG. 6D is a partial cross-sectional view of the disconnect switch of FIG. 6A in an opened state.

### DETAILED DESCRIPTION

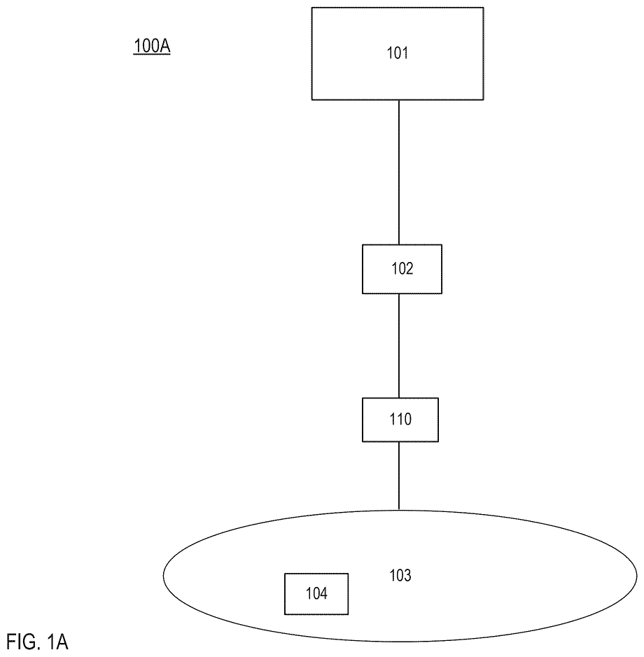

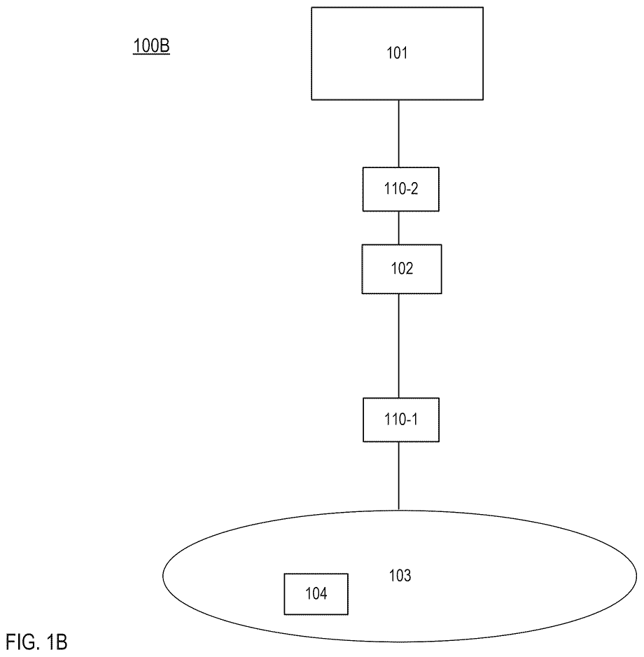

FIG. 1A is a block diagram of a system 100A. The system 100A includes an electrical power source 101, a protection apparatus 102, and a disconnect switch 110. The disconnect switch 110 may be used to electrically isolate a secondary distribution network 103 from the electrical power source 101 to allow repair, maintenance, or upgrades to the secondary distribution network 103. The electrical power source 101 is any source of alternating current (AC) electrical power. For example, the source 101 may be a node in an AC power grid or a transformer electrically connected to an AC power grid. The protection apparatus 102 may be, for example, a network protector. The distribution network 103 may be a low-voltage network, such as a secondary electrical distribution network (a spot network or an area network).

As discussed below, the disconnect switch 110 has a relatively low-profile design that may be used in small spaces, such as electrical vaults. Additionally, in some implementations, the disconnect switch 110 includes an integrated fuse, further reducing the overall size of the switch 110 and providing a design that may be used without an external fuse. The disconnect switch 110 also may include a visible break indication to allow personnel to confirm that the disconnect switch 110 is opened prior to working on the secondary distribution network 103. Furthermore, the disconnect switch 110 may be configured to prevent a movable electrical contact from being completely removed from the disconnect switch 110. By retaining the movable electrical contact in the disconnect switch 110, the movable electrical contact is protected from the elements. Moreover, retaining the movable electrical contact in the disconnect switch also improves the usability of the disconnect switch 110.

The disconnect switch 110 may be rated for currents of, for example, 800 amps (A) to 2000 A, 2250 A to 3500 A, or 4500 A to 6000 A. Although the disconnect switch 110 is not necessarily a load break switch, the disconnect switch 110 may be rated to interrupt a relatively low current (for example, a magnetizing current of 20 A or less) that can flow out of the secondary distribution network 103.

Prior to discussing examples of the disconnect switch 110, an overview of the system 100 is provided. The protection apparatus 102 is any type of device that is capable of repeatedly opening and closing an electrical connection. For example, the protection apparatus 102 may be a network protector, recloser, a circuit breaker, or switchgear. The protection apparatus 102 may be rated for electrical currents of, for example, up to 4.5 kiloamps (kA) and voltages of up to 600 volts (V).

The distribution network 103 may be a low-voltage network, such as a secondary electrical distribution network (a spot network or an area network) that includes one or more loads 104. The loads 104 may be, for example, a variety of electrical loads that are all within one large building or location, such as an airport terminal, a hospital, or an apartment building. The loads 104 may be any type of device, system, or component that uses electricity. The loads 104 may be a single load item or a collection of load items. For example, the loads 104 may be or include a motor, a lighting system, an industrial system, a climate controller, or a distributed energy resource (DER). A DER is an electricity-producing resource and/or a controllable load. Examples of DER include, for example, solar panels; wind turbines; combined heat and power plants; rechargeable sources (such as batteries); natural gas-fueled generators; electric vehicles; and controllable loads, such as, for example, some heating, ventilation, air conditioning (HVAC) systems and electric water heaters.

The power source 101 provides AC electric power that has a fundamental frequency of, for example, 50 or 60 Hertz (Hz). For example, the source 101 may be a generator, a power plant, an electrical substation, a transformer, or a renewable energy source. The power source 101 may be a low-voltage (for example, up to 1 kV), medium-voltage or distribution voltage (for example, between 1 kV and 35 kV), or high-voltage (for example, 35 kV and greater) AC power source. The voltage ranges provided for low-voltage, medium-voltage, distribution voltage, and high-voltage are examples, and an AC source that has an operating voltage in one of the provided ranges may be used as the power source 101 even if the operating voltage of that power source is referred to by a different term. Moreover, the power source 101 may receive power from other electrical power sources that are not shown in FIG. 1A. For example, the power source 101 may be a medium-voltage substation that receives and transforms high-voltage AC power at a transformer into medium-voltage AC power. In this example, the medium-voltage AC power is provided to the distribution network 103 through the protection apparatus 102 and the disconnect switch 110 when the protection apparatus 102 and the disconnect switch 110 are closed.

The arrangement shown in FIG. 1A is an example, and the disconnect switch 110 may be used in other ways and in other configurations. FIG. 1B is a block diagram of a system 100B. The system 100B is the same as the system 100A (FIG. 1A), except the system 100B includes two disconnect switches 110-1 and 110-2. Each disconnect switch 110-1 and 110-2 is identical to the disconnect switch 110 discussed with respect to FIG. 1A. The disconnect switch 110-1 is between the protection device 102 and the secondary distribution network 103, and the disconnect switch 110-2 is between the protection device 102 and the AC power source 101.

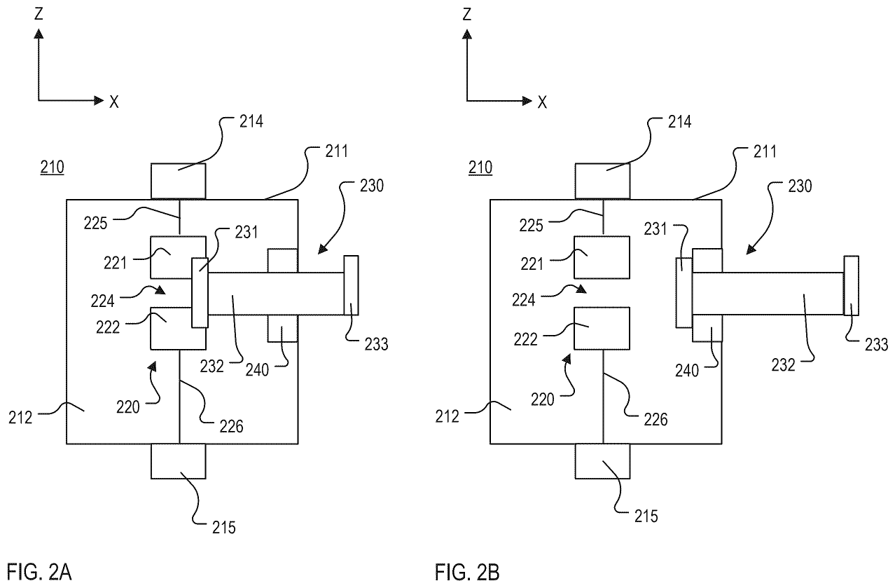

FIGS. 2A and 2B are cross-sectional views of a disconnect switch 210. The disconnect switch 210 is an example of a switch that can be used in the system 100A (FIG. 1A) or the system 110B. FIG. 2A shows the disconnect switch 210 in a closed state, and FIG. 2B shows the disconnect switch in an opened state. When in the opened state, the disconnect switch 210 provides electrical isolation between a first terminal 214 and a second terminal 215. When the disconnect switch 210 is in the closed state, the first terminal 214 is electrically connected to the second terminal 215. The disconnect switch 210 may be used to provide electrical isolation between two devices or systems in an electrical power grid. For example, the disconnect switch 210 may be between a secondary side of a transformer and a network protector, with the first terminal 214 electrically connected to the secondary side of the transformer and the second terminal 215 electrically connected to the network protector. In this example, when the disconnect switch 210 is in the opened state, the secondary side of the transformer and the network protector are not electrically connected. In another example, the disconnect switch 210 may be between a network protector and a secondary distribution network, with the first terminal 214 electrically connected to the network protector and the second terminal 215 electrically connected to the secondary distribution network. In this example, when the disconnect switch 210 is in the opened state, the secondary distribution network and the network protector are not electrically connected.

The disconnect switch 210 includes a housing 211 and a stationary contact assembly 220 in an interior 212 of the housing 211. The stationary contact assembly 220 includes first and second electrically conductive stationary (or fixed) contacts 221 and 222 that are separated from each other along the Z axis by a gap 224. The first stationary contact 221 is electrically connected to the first terminal 214 through an electrical connection 225. The second stationary contact 222 is electrically connected to the second terminal 215 through an electrical connection 226.

The disconnect switch 210 also includes a movable contact assembly 230. The movable contact assembly 230 includes an electrically conductive movable contact 231 mounted to a mechanical coupling 232 and an interface 233 that drives the mechanical coupling 232 to move the movable contact 231. The interface 233 has at least two stable states, one of which corresponds to the movable contact 231 being in a first position (FIG. 2A) and another of which corresponds to the movable contact 231 being in a second position (FIG. 2B). When in the first position, the movable contact 231 is electrically connected to the stationary contacts 221 and 222. When in the second position, the movable contact 231 is not electrically connected to the stationary contacts 221 and 222.

The position and motion of the movable contact 231 are determined by the state of the interface 233. The interface 233 is accessible from outside of the housing 211. In the example shown in FIGS. 2A and 2B, the mechanical coupling 232 is a rod that passes through the housing 211 and the interface 233 is on an end of the rod. To transition the disconnect switch 210 from the closed state (FIG. 2A) to the opened state (FIG. 2B), the interface 233 is activated such that the mechanical coupling 232 moves in the X direction. The motion of the mechanical coupling 232 also moves the movable contact 231 in the X direction, separating the movable contact 231 from the stationary contacts 221 and 222, and opening the disconnect switch 210 (FIG. 2B).

The interface 233 may be configured for manual operation by, for example, a human technician. For example, the interface 233 may include a handle that moves the mechanical coupling 232 in response to manual manipulation (such as pushing or pulling). In some implementations, the interface 233 is configured for automated operation. For example, the interface 233 may include or be coupled to a mechanized device, such as a motor, that is controllable to apply force to the mechanical coupling 232. In these implementations, the disconnect switch 210 may be operated remotely through the mechanized device and without a human technician necessarily being present.

Although the interface 233 causes the movable contact 231 to move in the X direction, a blocking assembly 240 prevents the movable contact 231 from being completely removed from the housing 211. Preventing the movable contact 231 from being completely removed from the interior 212 of the housing 211 improves the usability of the disconnect switch 210 as compared to a configuration that lacks the blocking assembly 240. For example, because the movable contact assembly 230 remains mounted in and supported by the housing 211, personnel working with the disconnect switch 210 do not have to concern themselves with finding a suitable place to leave the movable contact assembly 230 outside of the housing 211 while working. Furthermore, by remaining in the interior 212, the movable contact 231 is protected from debris and damage while the personnel work. Additionally, the movable contact assembly 230 may be heavy and/or awkwardly shaped, and retaining the movable contact assembly 230 in the housing 211 eliminates the need for personnel to lift and/or move the entire weight of the movable contact assembly 230.

To transition the disconnect switch 210 to the closed state, the interface 233 is activated (manually or through a mechanized device) to move the mechanical coupling 232 in the-X direction, which also moves the movable contact 231 in the-X direction until the movable contact 231 is connected to the stationary contacts 221 and 222. Because the movable contact assembly 230 is not completely removed from the housing 211 during the opening procedure, the operator or other personnel using the disconnect switch 210 do not have to reposition the movable contact assembly in the housing 211. Thus, the blocking assembly 240 also facilitates an efficient closing procedure for the disconnect switch 210. Moreover, retaining the movable contact 231 in the housing 211 also allows the interface 233 to be more easily and more simply mechanized because the mechanized process does not face the challenge of placing the movable contact 231 outside of the housing 211.

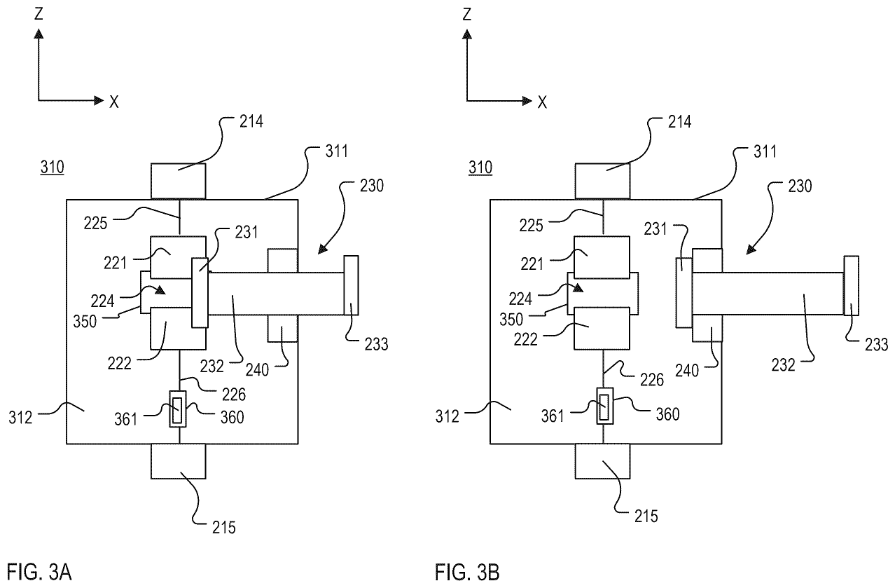

FIGS. 3A and 3B are cross-sectional views of a disconnect switch 310. FIG. 3A shows the disconnect switch 310 in the closed state. FIG. 3B shows the disconnect switch 310 in the opened state. The disconnect switch 310 is another example of a switch that can be used in the system 100 as the disconnect switch 110. The disconnect switch 310 is the same as the disconnect switch 210 except the disconnect switch 310 includes a fuse system 360 and a housing 311 that includes a viewing window 350. The fuse system 360 holds a fuse 361 in electrical contact with the electrical connection 226. The fuse 361 is any type of fuse. For example, the fuse 361 may be a current-limiting fuse.

The viewing window 350 is a window that is in a wall of the housing 311. The viewing window 350 is a transparent covering that is aligned with the gap 224 such that the gap 224 can be observed from outside the housing 311. This allows observation of the gap 224 from outside of the housing 311. When the gap 224 is completely open and free of obstructions (such as shown in FIG. 3B), only the stationary contacts 221 and 222 are visible through the window 350 and the disconnect switch 310 is in the opened state. When the movable contact 231 is visible through the viewing window 350 (such as shown in FIG. 3A), the movable contact 231 is connected to the stationary contacts 221 and 222 and the disconnect switch 310 is in the closed state.

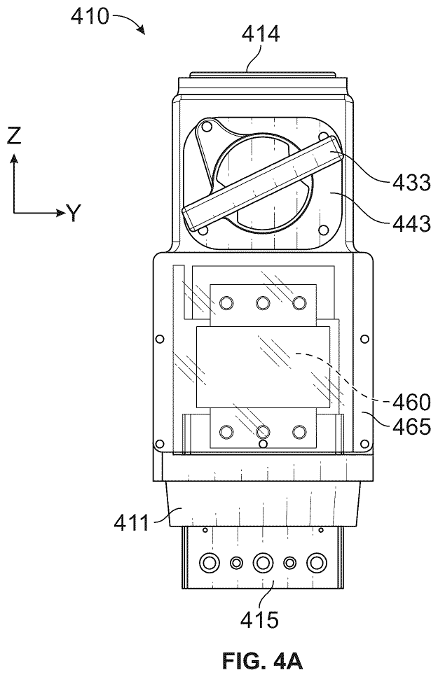

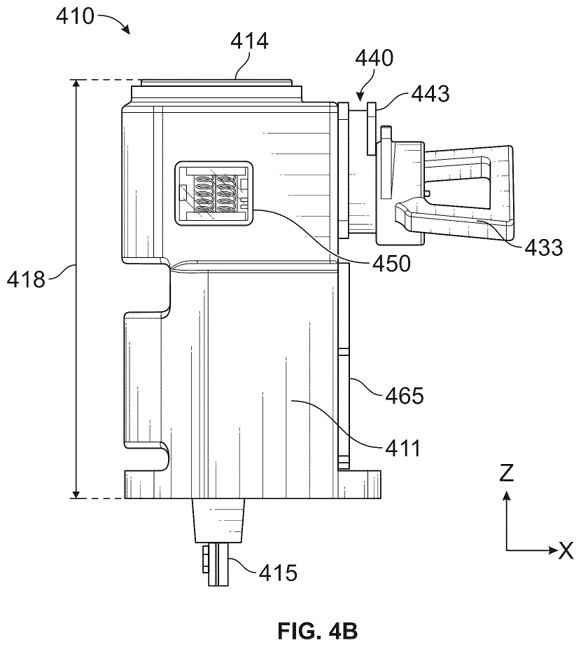

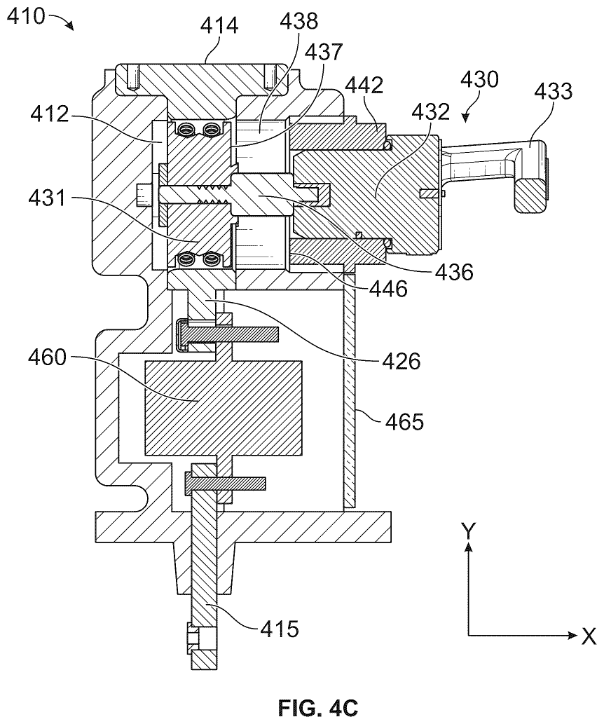

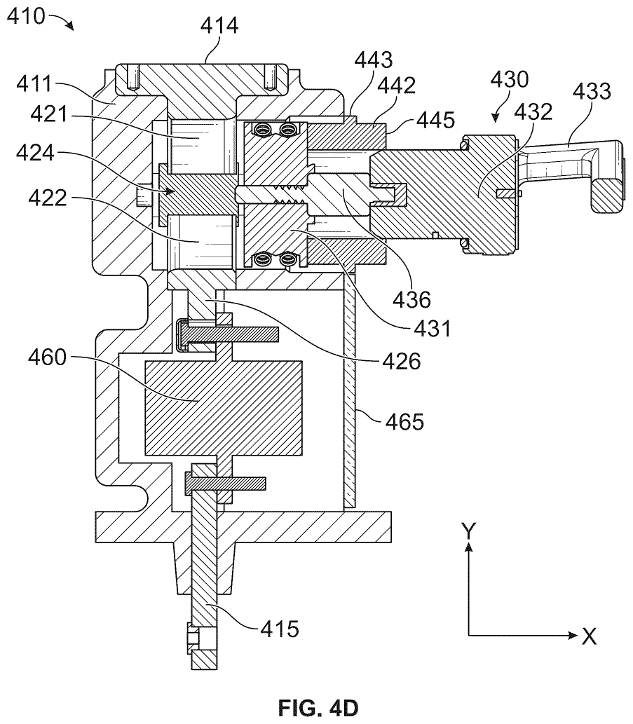

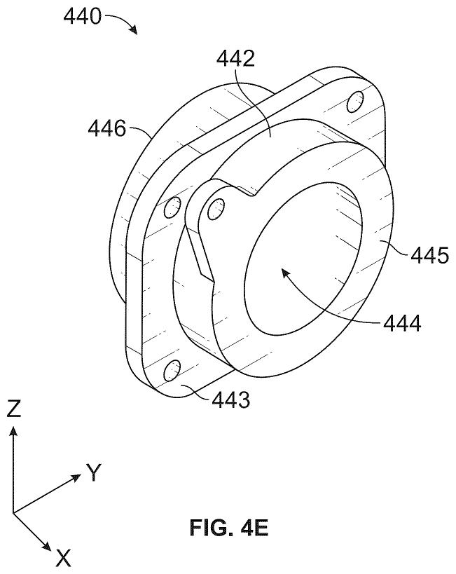

FIGS. 4A-4D show a disconnect switch 410. The disconnect switch 410 is another example of a disconnect switch that can be used in a system such as the system 100. FIG. 4A is an exterior front view of the disconnect switch 410 and FIG. 4B is an exterior side view of the disconnect switch 410. The disconnect switch 410 includes a housing 411 and electrically conductive terminals 414, 415 that extend through the housing 411. The housing 411 is a solid, rugged, and opaque material. For example, the housing 411 may be a solid and hardened polymer or rubber material. In some implementations, the housing 411 is made of ethylene propylene diene monomer (EPDM).

The housing 411 includes a visible break window 450 and a fuse window 465. The visible break window 450 and the fuse window 465 are made of a transparent or partially transparent material that allows an observer outside of the housing 411 to view a portion of an interior 412 (FIGS. 4C and 4D) of the housing 411. For example, the visible break window 450 and the fuse window 465 may be clear plastic windows formed into the housing 411. In some implementations, the visible break window 450 and/or the fuse window 465 may be partially or completely removable to allow an observer to access the interior 412 of the housing 411. For example, the fuse window 465 may be a door. In these implementations, the window 450 and/or 465 is not necessarily made of a transparent or partially transparent material because the observer can move the window 450 and/or 465 to observe the interior 412. The housing 411 may include additional or fewer windows. For example, the housing 411 may include two of the visible break windows 450 on opposite sides of the housing 411. In another example, the housing 411 may include only the visible break window 450 but not the fuse window 465.

The disconnect switch 410 also includes a handle interface 433 and a blocking assembly 440 that prevents the handle interface 433 from being completely removed or completely separated from the housing 411. Referring also to FIG. 4C, which is a side cross-sectional view of the disconnect switch 410 in a closed state, the handle interface 433 is part of a movable contact assembly 430. The movable contact assembly 430 includes a coupling body 432 and a connection rod 436 that is attached to the coupling body 432, and a movable contact 431 that is attached to the connection rod 436.

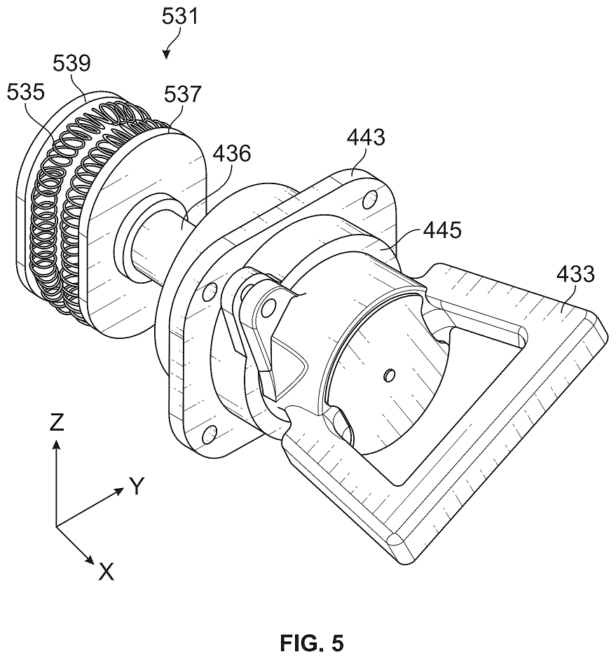

The movable contact 431 may have any shape in the Y-Z plane. For example, the movable contact 431 may be circular in the Y-Z plane or may have a non-circular shape in the Y-Z plane. Any non-circular shape may be used. Examples of non-circular shapes that the movable contact 431 may have include, without limitation, elliptical, rectangular, square, hexagonal, and triangular. FIG. 5 shows an example of a movable contact 531, which has an elliptical shape in the Y-Z plane and may be used in the disconnect switch 410.

Referring also to FIG. 4E, which is a perspective view of the blocking assembly 440, the blocking assembly 440 includes a flange 443 that extends radially outward from a hollow body 442. The hollow body 442 extends from a first end 445 to a second end 446. The hollow body 442 is received in an opening 416 of the housing 411 with the flange 443 mounted on an exterior side of the housing 411. The blocking assembly 440 is secured to the housing 411 by securing the flange 443 to the exterior side of the housing 411. The hollow body 442 passes through the housing 411 with the second end 446 in the interior 412 of the housing 411. The blocking assembly 440 is fixedly mounted to the housing 411 does not move relative to the housing 411.

The coupling body 432 is received in an open interior 444 of the blocking assembly 440. The coupling body 432 has a diameter in the Y-Z plane that is slightly smaller than the diameter of the open interior 444 such that the coupling body 432 can move in the +/−X directions in the open interior 444. The moving contact 431 has a diameter that is larger than the diameter of the open interior 444.

In the example shown, the connection rod 436 is received in a center of the movable contact 431. The movable contact assembly 430 moves as a single element. Thus, moving the handle interface 433 also moves the movable contact 431. The movable contact 431 is made of an electrically conductive material, such as, for example, copper, brass, silver, gold, and/or aluminum. The handle interface 433 is electrically insulated from the movable contact 431 and is safe for manual operation. For example, a human operator may grasp the handle interface 433 safely and without concern of injury.

Referring also to FIG. 4D, which is a side cross-sectional view of the disconnect switch 410 in the opened state, the disconnect switch 410 also includes stationary contacts 421 and 422, which are separated in the Z direction by a gap 424. The stationary contacts 421 and 422 are fixed in place and the gap 424 is sufficient to electrically isolate the stationary contacts 421 and 422 from each other. The stationary contacts 421 and 422 are made of an electrically conductive material such as, for example, copper, brass, silver, gold, and/or aluminum. The stationary contact 421 is electrically connected to the electrically conductive terminal 414. The stationary contact 422 is electrically connected to an electrical connection 426.

The electrical connection 426 is electrically connected to a fuse assembly 460. The fuse assembly 460 includes a fuse that is electrically connected to the electrical connection 426 and the electrically conductive terminal 415. The fuse assembly 460 is integrated into the interior 412 of the housing 411. By including the fuse assembly 460 in the housing 411, the extent of the housing 411 in the Z direction (labeled as 418 in FIG. 4B) is less than a housing of a disconnect switch that does not include the integrated fuse assembly 460. For example, the extent 418 may be about 8 inches (about 20.3 centimeters) less than a design that lacks the integrated fuse assembly. This reduced height allows the disconnect switch 410 to be used in small spaces.

In ordinary operational use, when the disconnect switch 410 is in the closed state (FIG. 4C), electrical current flows from the electrically conductive terminal 414, into the stationary contacts 421 and 422 and the movable contact 431, into the electrical connection 426, through the fuse assembly 460 and into the electrically conductive terminal 415.

To transition the disconnect switch 410 from the closed state (FIG. 4C) to the opened state (FIG. 4D), force is applied to the handle interface 433 in the X direction. As discussed above, the movable contact assembly 430 moves as a single element. Thus, applying force to the handle interface 433 in the X direction also moves the coupling body 432, the connection rod 436, and the movable contact 431 in the X direction. The movable contact 431 moves off of the stationary contacts 421 and 422 and into a holding space 438. Referring to FIG. 4D, a side 437 of the movable contact 431 comes into contact with the second end 446 of the hollow body 442. The diameter of the movable contact 431 is greater than the diameter of the open interior 444. Thus, the movable contact 431 does not move through the open interior 444 and the handle interface 433 cannot be moved farther in the X direction. In this way, the blocking assembly 440 prevents the movable contact assembly 430 from being completely removed from the housing 411.

Force may be applied to the handle interface 433 manually, for example, by a human operator grasping the handle interface 433 and applying force by pulling the handle interface 433 in the X direction. In some implementations, force is applied to the handle interface 433 by a mechanized process. For example, a motor may be mounted to the handle interface 433 through a mechanical linkage to apply force to the handle interface 433 in the X direction and the-X direction. In these implementations, a movable contact 431 with a non-circular shape in the Y-Z plane may improve the performance of the disconnect switch 410 by preventing or limiting rotation of the movable contact 431 in the Y-Z plane. This allows the movable contact 431 to be driven in the X direction or the-X direction in a linear manner, thereby improving reliability and performance while also simplifying the motor and motor control scheme used to move the movable contact 431.

When the disconnect switch 410 is in the opened state (FIG. 4D), the movable contact 431 remains in the interior 412. The gap 424 electrically isolates the stationary contacts 421 and 422, the movable contact 431 is not in contact with the stationary contacts 421 and 422, and current cannot flow through the disconnect switch 410. The visible break window 450 (FIG. 4B) is aligned with the gap 424. The state of the disconnect switch 410 can be discerned by viewing the gap 424. Specifically, when the movable contact 431 is overlapped with the gap 424, the disconnect switch 410 is in the closed state. When the movable contact 431 is not overlapped with the gap 424, the disconnect switch 410 is in the opened state.

FIG. 5 is a perspective view of the movable contact 531. The movable contact 531 can be used in the disconnect switch 410 instead of the movable contact 431. The movable contact 531 is shown with the handle interface 433. The movable contact 531 includes a first contact 537 and a second contact 539. The contacts 537 and 539 are identical electrically conductive elements that have an elliptical shape in the Y-Z plane. The contacts 537 and 539 are made of an electrically conductive material such as, for example, copper, tin, aluminum, gold, or silver. The contacts 537 and 539 are mounted on an end of the connection rod 436.

The contacts 537 and 539 are separated in the X direction with a coiled element 535 between the contacts 537 and 539. The coiled element 535 is electrically conductive and may be, for example, a canted coil spring or a flexible and electrically conductive element that mechanically connects the contacts 537 and 539 and conducts electrical current. The coiled element 535 also centers and/or aligns the contacts 537 and 539 with each other.

The elliptical shape of the contacts 537 and 539 prevents or restricts rotation of the movable contact 531 when the movable contact 531 is used in a disconnect switch (such as the disconnect switch 410). For example, when the movable contact 531 is used in the disconnect switch 410, the movable contact 531 is driven in the X direction to open the disconnect switch 540 and in the-X direction to close the disconnect switch 540. The shape of the contacts 537 and 539 in the Y-Z plane prevents the movable contact from rotating in the Y-Z plane while the movable contact 531 is driven in the X and -X directions. This arrangement promotes purely linear motion of the movable contact 531 and can result in a simplified and/or more reliable process for opening and closing the disconnect switch.

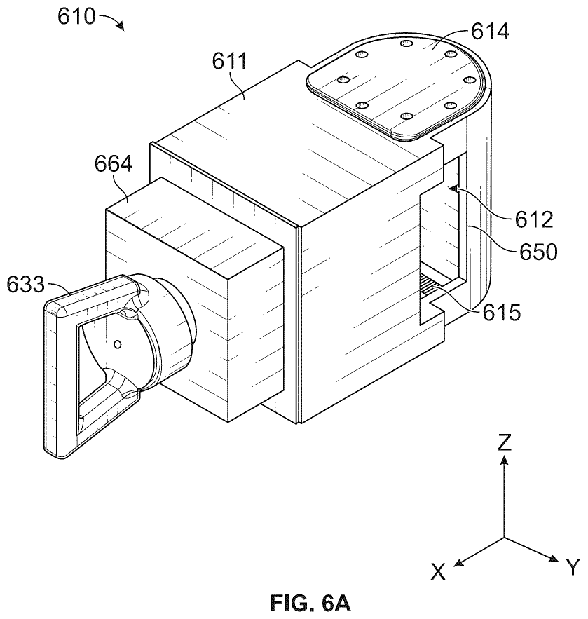

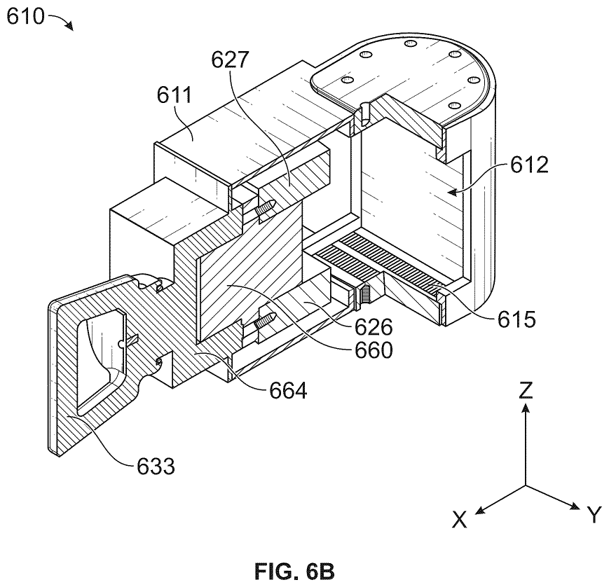

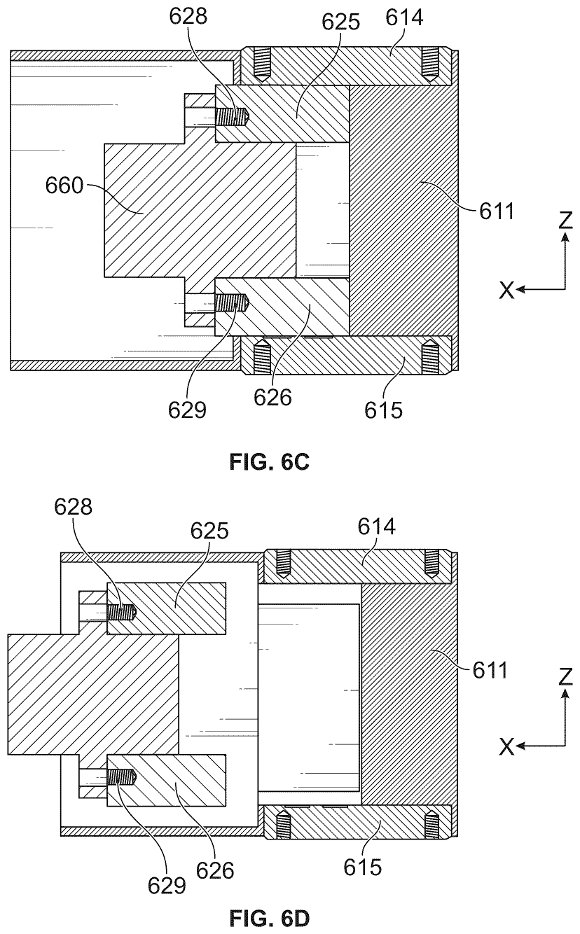

FIGS. 6A-6D relate to a disconnect switch 610. The disconnect switch 610 is another example of a disconnect switch that can be used in a system such as the system 100. FIG. 6A is an exterior perspective view of the disconnect switch 610. The disconnect switch 610 includes a housing 611 and a handle interface 633. The housing 611 may be made of a polymer material, such as EPDM. The housing 611 includes a visible break window 650 that allows a portion of an interior 612 of the housing 611 to be viewed from the outside of the housing 611. The disconnect switch 610 also includes a first electrical terminal 614 on a first side of the housing 611 and a second electrical terminal 615 on an opposite side of the housing 611. The terminals 614 and 615 are separated from each other in the Z direction and are not in direct physical contact.

FIG. 6B is a perspective cross-sectional view of the disconnect switch 610. The disconnect switch 610 includes a fuse assembly 660 that is electrically connected to an electrical connection 624, which is electrically connected to the first electrical terminal 614, and an electrical connection 625, which is electrically connected to the second electrical terminal 615. The second electrical terminal 615 includes a plurality of hardened electrically conductive strips. The fuse assembly 660 is received in a mounting block 664, which is attached to the handle interface 633.

FIG. 6C is a partial cross-sectional side view of the disconnect switch 610 in a closed state. When the disconnect switch 610 is in the closed state, electrical current flows into the first electrical terminal 614. The first electrical connection 625 is in physical contact with the first electrical terminal 614, and electrical current flows between the terminal 614 and into the first electrical connection 625. The electrical connection 625 is electrically connected to the fuse assembly 660 by a first conductive connection point 628, and the fuse assembly 660 is electrically connected to the fuse assembly 660 by a second conductive connection point 629. The conductive connection points 628 and 629 may be metallic screws or pegs. The second conductive connection point 629 is electrically connected to the electrical connection 626, which is electrically connected to the terminal 615. Thus, when the disconnect switch 610 is in the closed state, the terminals 614 and 615 are electrically connected.

To transition the disconnect switch 610 to the opened state, the handle interface 633 is moved in the X direction. The handle interface 633 may be moved manually or by a motor. The fuse assembly 660 and the electrical connections 624 and 625 move with the handle interface 633 relative to the housing 611. The terminals 614 and 615 do not move relative to the housing 611. Thus, in the disconnect switch 610, the terminals 614 and 615 are stationary or fixed electrical contacts and the electrical connections 624 and 625 are movable electrical contacts. The disconnect switch 610 is in the opened state when the electrical connections 624 and 625 are no longer in contact with the respective terminals 614 and 615. FIG. 6D is a partial cross-sectional view of the disconnect switch 610 in the opened state.

These and other implementations are within the scope of the claims.

What is claimed is:

1. A disconnect switch comprising:
a housing;
a first stationary contact in an interior of the housing;
a second stationary contact in the interior of the housing;
a disconnection assembly comprising:
a movable electrical contact; and
an operating interface accessible from an exterior of the housing and coupled to the movable electrical contact, the operating interface configured to move the movable electrical contact into and out of electrical connection with the first and second stationary contacts; and
a blocking assembly configured to prevent the movable electrical contact from being removed from the interior of the housing.

2. The disconnect switch of claim 1, wherein the first stationary contact and the second stationary contact are separated by a gap; and, when the movable electrical contact is in electrical connection with the first and second stationary contacts, the movable contact touches the first and second stationary contacts.

3. The disconnect switch of claim 1, further comprising a fuse in the interior of the housing, the fuse electrically connected to the second stationary contact.

4. The disconnect switch of claim 1, wherein the movable electrical contact is mounted on a rod that extends along an axis, the movable electrical contact extends in a plane perpendicular to the axis.

5. The disconnect switch of claim 4, wherein the movable electrical contact is shaped to restrict rotation in the plane.

6. The disconnect switch of claim 5, wherein the movable electrical contact has a non-circular shape in the plane.

7. The disconnect switch of claim 4, wherein the operating interface is configured to move the movable electrical contact along the axis.

8. The disconnect switch of claim 7, wherein the operating interface is a handle configured to be pulled away from the housing to move the movable electrical contact out of electrical connection with the first and second stationary electrical contacts and to be pushed toward the housing to move the movable electrical contact into electrical connection with the first and second stationary electrical contacts.

9. The disconnect switch of claim 1, further comprising a visible break system that provides a perceivable indication of whether or the movable electrical contact is electrically connected to the first and second stationary electrical contacts.

10. The disconnect switch of claim 9, wherein the visible break system comprises at least one window aligned with a region between the first stationary contact and the second stationary contact.

11. The disconnect switch of claim 1, wherein the operating interface is configured for manual manipulation, and wherein the operating interface moves the movable contact in response to manual manipulation.

12. The disconnect switch of claim 1, wherein the operating interface is driven by a mechanized element.

13. The disconnect switch of claim 12, wherein the mechanized element comprises a motor.

14. A fused disconnection system comprising:
a first stationary contact;
a second stationary contact separated from the first stationary contact;
a fuse; and
a movable electrical contact configured to move between a first position and a second position, wherein, when the movable electrical contact is in the first position, the first stationary contact, the second stationary contact, and the fuse are electrically connected; and, when the movable electrical contact is in the second position, the first stationary contact and the second stationary contact are not electrically connected.

15. The fused disconnection system of claim 14, wherein the fuse moves with the movable electrical contact.

16. The fused disconnection system of claim 14, further comprising a housing, and wherein the movable electrical contact moves relative to the housing, and the fuse is in the housing.

17. The fused disconnection system of claim 16, wherein the housing comprises a view window aligned with the first and second stationary contacts.

18. The fused disconnection system of claim 14, further comprising: a first electrical terminal electrically connected to the first stationary contact; and a second electrical terminal electrically connected to the second stationary contact.

19. The fused disconnection system of claim 18, wherein the second electrical terminal is electrically connected to the second stationary contact through the fuse.

20. The fused disconnection system of claim 14, wherein the first stationary contact is accessible from an exterior of the housing; the second stationary contact is accessible from an exterior of the housing; and each of the first and second stationary contacts are configured to electrically connect to an external device.
